(19) United States
(12) Patent Application Publication
(10) Pub. No.: US 2005/0064149 A1
(43) Pub. Date: Mar. 24, 2005

(54) Resin frame with a net, manufacturing method thereof, and molding equipment used in the manufacturing method

(76) Inventors: Toru Iseki, Okazaki-shi (JP); Takehiko Kawashima, Hashima-shi (JP)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/987,027

(22) Filed: Nov. 12, 2004

(30) Foreign Application Priority Data
Sep. 2, 2002 (JP) 2002-256712

(51) Int. Cl. B29C 45/14

(52) U.S. Cl. 428/192; 264/275; 264/279; 425/125; 425/127

(57) ABSTRACT

The resin frame includes a fixture frame formed with resin and a net, fixed and extended within the fixture frame. The resin frame with a net is formed by projecting resin so as to enclose a portion of a spread net so as to make the fixture frame, and then by cutting off the net outside of the fixture frame. The cut section made by cutting off the net outside the fixture frame is formed in a groove on the resin frame, and hidden when the resin frame is attached to the framing of a chair. The resin frame with a net formed according to the present invention is visually presentable by ensuring that the cut portion of the net is not easily visible.

### BACKGROUND OF THE INVENTION

(1) Field of the Invention

This invention relates to a resin frame with a net, a manufacturing method thereof, and molding equipment used in the manufacturing method.

(2) Background Art

A conventional resin frame 100 with a net, such as the one shown in FIGS. 7 and 8, has breathability, and is widely used for the back rests and seats of chairs.

This resin frame 100 is manufactured by using molding equipment 200 shown in FIG. 9 comprising an upper and a lower mold, 210 and 212.

On the bottom surface of the upper mold 210, the shape of the back side of a fixture frame 120 (see FIGS. 7 and 8) is formed. On the other hand, the shape of the front side of the fixture frame 120 is formed on the top surface of the lower mold 212.

For manufacturing a resin frame 100 with a net by using the molding equipment 200, firstly a net 110 is spread on the lower mold 212. While the net 110 is held by net holders 216, disposed on the ends of the upper mold 210, the upper mold 210 is placed on the lower mold 212. The net 110 is extended and sandwiched between the molds, 210 and 212. A molding space 214 in the shape of the fixture frame 120 is formed between these molds, 210 and 212. At this time, the net 110 has been laid across the molding space 214.

Secondly, resin is projected into the molding space 214 through a gate 218 formed in the lower mold 212. When the resin is solidified, the net 110 and the fixture frame 120 are removed from the molding equipment 200, and the net 110b, outside the fixture frame 120, is cut off. Consequently, a resin frame 100 is formed with a net 110a extended within the fixture frame 120, from amongst the entire portion of the net 110 that was originally extended on the lower mold 212.

### SUMMARY OF THE INVENTION

However, in a conventional resin frame 100 with a net, a cut section 110c (see the fringe of the frame 100 in FIGS. 7 and 8) is formed after cutting off the net 110b from a portion of the fixture frame 120 and is visible outside of the fixture frame 120. Therefore, a conventional resin frame is not visually presentable because of the conspicuous cut section 110c.

In order to hide the cut section 110c of a conventional resin frame 100 with a net, the fixture frame 120 is covered with resin after the net lob is cut off. Due to the heat of the resin covering the fixture frame 120, the resin forming the fixture frame 120 is melted and this causes the loosening of the tension of the net 110a.

It is one of the objects of the present invention to provide a resin frame with a net wherein the above and other issues are solved and wherein the frame is visually presentable, a manufacturing method thereof, and molding equipment used in the manufacturing method.

To attain this and other objects, the present invention provides a resin frame with a net wherein a fixture frame is formed by projecting resin so as to enclose one part of the net and another part of the net outside of the fixture frame is removed. In this resin frame with a net, a cut section, made by removing the net outside of the fixture frame, is formed on a surface of the fixture frame (covered surface) which is to be at least partially covered by an attachment target when the resin frame with the net is attached thereto.

In the resin frame with a net, the cut section is formed on the covered surface of the fixture frame. Therefore, the cut section is hidden when the resin frame is attached to an attachment target.

According to the above configuration, a resin frame with a net can be visually presentable.

Moreover, according to the present invention, the cut section becomes hidden from the outside when the resin frame is attached to an attachment target. Unlike conventional resin frames, it is not necessary to cover the fixture frame with additional resin in order to hide the cut section. The covering process which was conventionally required can be skipped in the manufacturing of the resin frame with a net of the present invention. Therefore, the efficiency in the manufacture can be improved.

Furthermore, since the fixture frame of the resin frame of the present invention does not need additional covering with hot melted resin, the resin forming the fixture frame does not melt due to the heat of the covering resin. Therefore, the tension of the net does not loosen.

The resin frame with a net according to the present invention could be manufactured by using molding equipment comprising a first, a second, and a third mold. The first mold has a shape so as to form an uncovered surface side of the fixture frame, on the top surface thereof. The second mold has an opening. On the internal edge of the bottom surface of the second mold, on which the opening is abutted, is a shape to form the portion on the covered surface side of the fixture frame exterior to the part where the cut section is formed. The third mold has a convex portion insertable into the opening of the second mold. On an end of the convex portion, the third mold has a shape so as to form the portion on the covered surface side of the fixture frame interior to the part where the cut section is formed. When the convex portion of the third mold is inserted into the opening of the second mold, and when the second and third molds are placed on the first mold, a molding space in the shape of the fixture frame is formed among the first, second, and third molds. The resin frame with a net of the present invention can be manufactured by the above-described molding equipment, and by a method comprising steps of spreading the net to cover the opening of the second mold; pressing the net covering the opening with the convex portion of the third mold; inserting the convex portion into the opening; and projecting (injecting) resin into the molding space.

In the manufacturing method of the present invention, a net is spread so as to cover the opening of the second mold, extended, and held when the net is pressed by the convex portion of the third mold. The portion of the net pressed by the convex portion is sandwiched between the first and third molds. The net protrudes from the molding space, via the sandwiched area defined between the opening of the second mold and the convex portion of the third mold. The sandwiched area includes a portion of the resin frame wherein the cut section is to be formed. When resin is projected into the molding space and solidified, the portion of the net inside the area bounded by the fixture frame is extended in tension therein. The portion of the net outside the fixture frame protrudes from the covered surface area of the fixture frame.

Therefore, when the net outside of the fixture frame is removed, the net extends inside of the fixture frame without loosening and forms a visually presentable resin frame with a net.

In order to manufacture the resin frame with a net of the present invention as above, it is preferable to use the molding equipment described below. The preferable molding equipment comprises a first, a second, and a third mold. The first mold has a shape so as to form an uncovered surface side of the fixture frame, on the top surface thereof. The second mold has an opening. On the internal edge of the bottom surface of the second mold, on which the opening is abutted, is a shape so as to form the portion on the covered surface side of the fixture frame exterior to the part where the cut section is formed. The third mold has a convex portion insertable into the opening of the second mold. On the edge of the bottom surface of the convex portion, the third mold has a shape so as to form the portion on the covered surface side of the fixture frame interior to the part where the cut section is formed. In the preferable molding equipment, a molding space in the shape of the fixture frame is formed among the first, second, and third molds, when the convex portion of the third mold is inserted into the opening of the second mold, and when the second and third molds are placed onto the first mold.

### BRIEF DESCRIPTION OF THE DRAWINGS

The invention will now be described below, by way of an example, with reference to the accompanying drawings.

FIG. 1 is a perspective view of a resin frame with a net of an embodiment of the present invention from the rear surface side, to be hereinafter referred to as the covered surface side of the resin frame;

FIG. 2 is a perspective view of the fixture frame of the resin frame illustrated in FIG. 1 showing the fixture frame partly removed and enlarged;

FIG. 3 is a partially perspective side elevation of the molding equipment showing a net placed thereon;

FIG. 4 is a partially perspective side elevation of the molding equipment showing the net held or restrained by a net holder;

FIG. 5 is a partially perspective side elevation of the molding equipment showing the convex portion of the molding equipment inserted into the opening of the molding equipment;

FIG. 6 is a partially perspective side elevation of the r molding equipment showing removal of a molded resin frame with a net therefrom;

FIG. 7 is a perspective view of a conventional resin frame with a net;

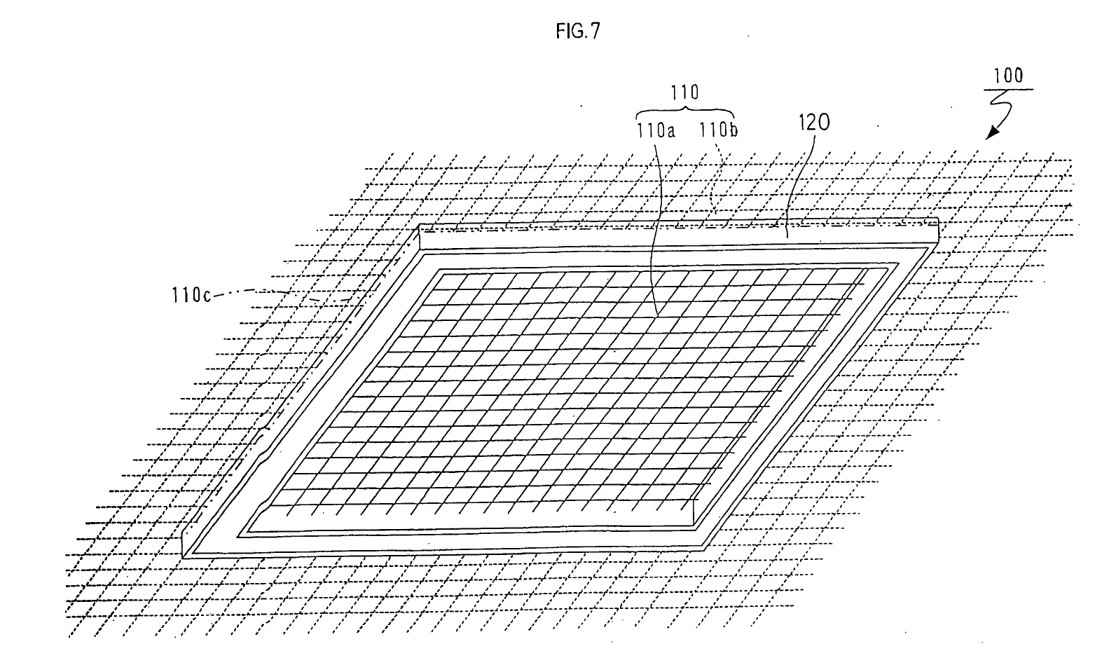

FIG. 8 is a perspective view of the fixture frame of the resin frame illustrated in FIG. 7 showing the fixture frame partly removed and enlarged; and

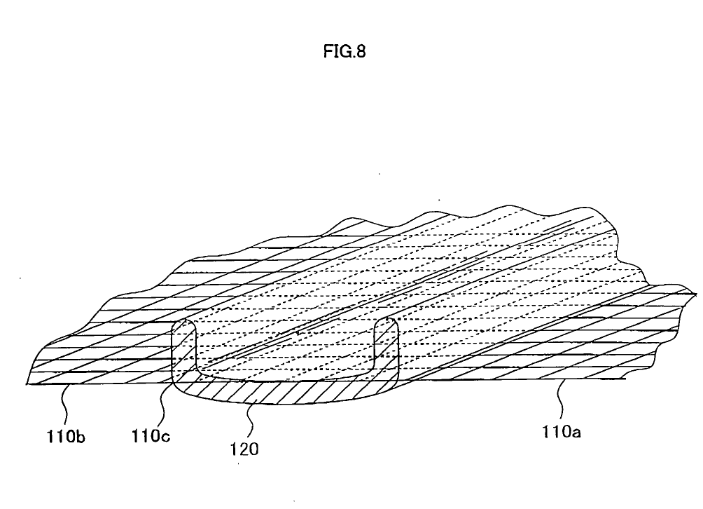

FIG. 9 is a partially perspective side elevation of molding equipment for manufacturing a conventional resin frame with a net with portions thereof cut away.

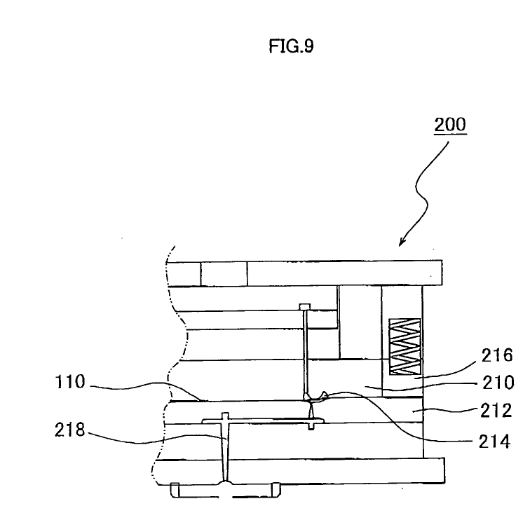

### DETAILIED DESCRIPTION OF THE PREFERRED EMBODIMENT

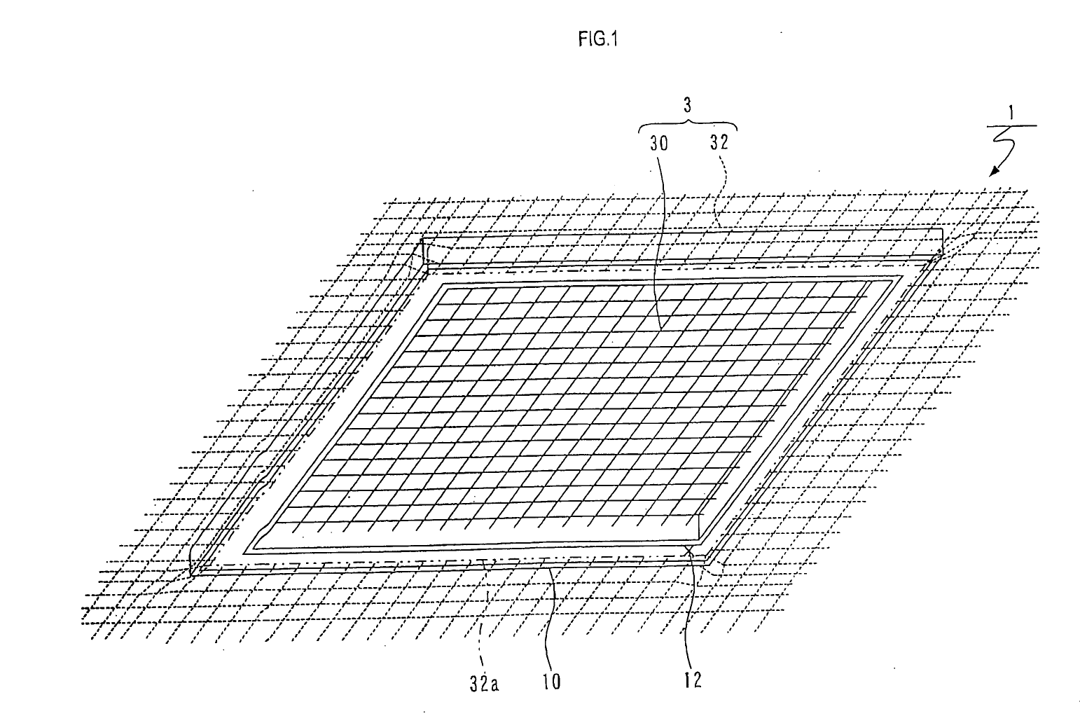

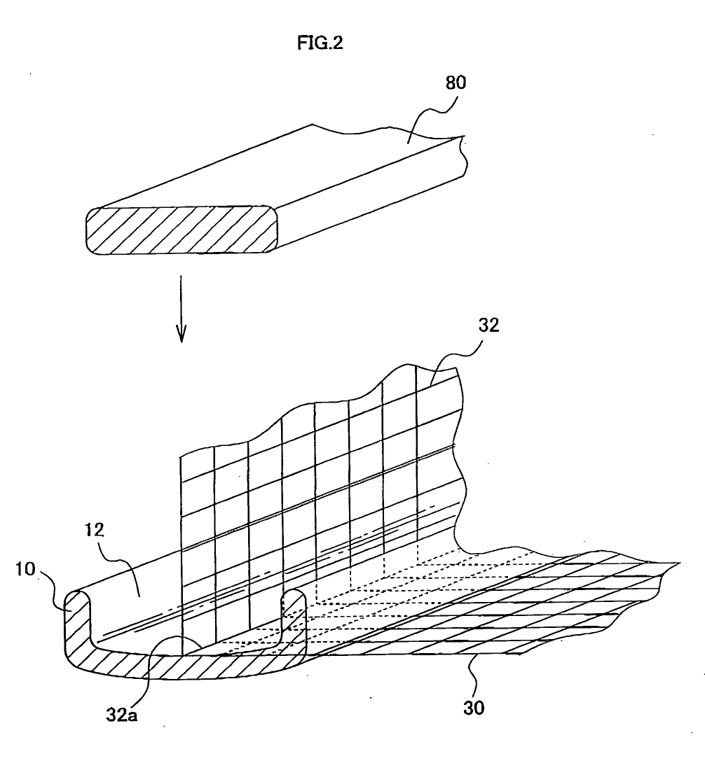

Referring to FIGS. 1 and 2, a resin frame 1 with a net of the present embodiment is used as a back rest and/or a seat of a chair, and comprises a fixture frame 10, constituted by resin, and a net 30 extended inside of the fixture frame 10. On the back side of the fixture frame 10, a groove 12 is formed along the fixture frame 10 for attaching the resin frame 1 to the framing of a chair. The chair frame is an attachment target 80 for the attachment of the resin frame 1.

The resin frame 1 with a net is formed as described in the following.

Firstly, a net 3 is spread, resin is projected so as to enclose one part of the net 3, and a fixture frame 10 is formed. At this time, the net 3 is disposed inside of the fixture frame 10 so as to protrude from the fixture frame 10 through the groove 12. In this embodiment, the protrusion of the net 3 through the groove 12 is at an angle to the general orientation of the fixture frame 10 (horizontal). The angle may help to retain the tightness of the net 3 stretched across the fixture frame 10. For example, in this embodiment the angle of the protrusion of the net 3 from the groove 12 is close to 90°.

Subsequently, the net 32 outside the fixture frame 10 is removed by cutting, and a cut section 32a of the net 32 outside of the fixture frame 10 is formed in the groove 12, due to the protrusion of the net 3 through the groove 12.

The frame of a chair is set into the groove 12 of the resin frame 1 formed as above. The cut section 32a of the resin frame 1 is therefore hidden by the framing in a location inconspicuous from outside.

Accordingly, the resin frame 1 with a net, of the present embodiment, is visually presentable because the cut section 32a is hidden from the outside when the frame of a chair is attached.

Moreover, it is not necessary to cover the fixture frame 10 with resin in order to hide the cut section 32a, as is normally done in the manufacturing process of a conventional resin frame with a net. Therefore, resin frames 1 of the present embodiment can be manufactured more efficiently as compared to a conventional resin frame with a net.

By not covering the fixture frame 10 with resin, loosening of the net 30 can be inhibited. The loosening is conventionally caused when the heat of melted resin that covers the fixture frame melts the resin forming the fixture frame.

The following describes in detail a manufacturing method of the above-described resin frame with a net and the molding equipment used in this method.

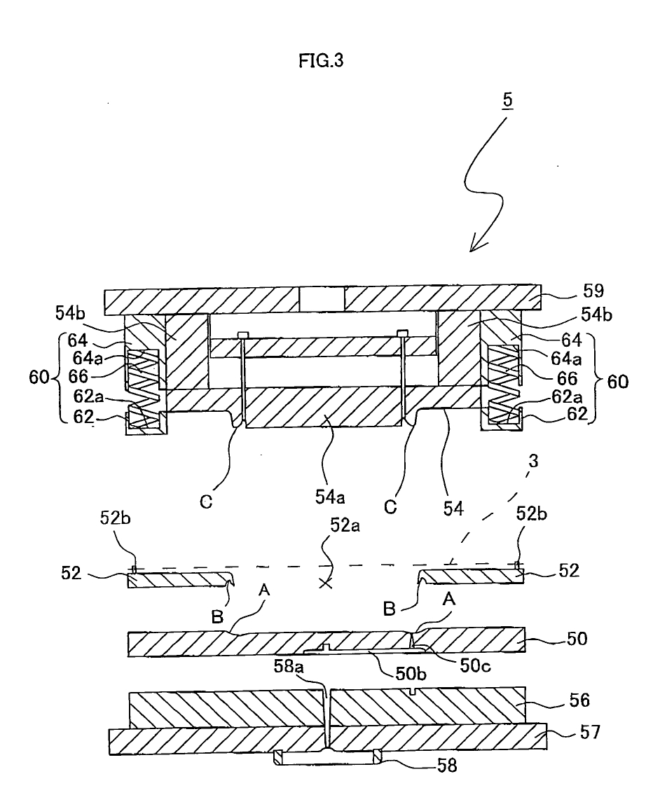

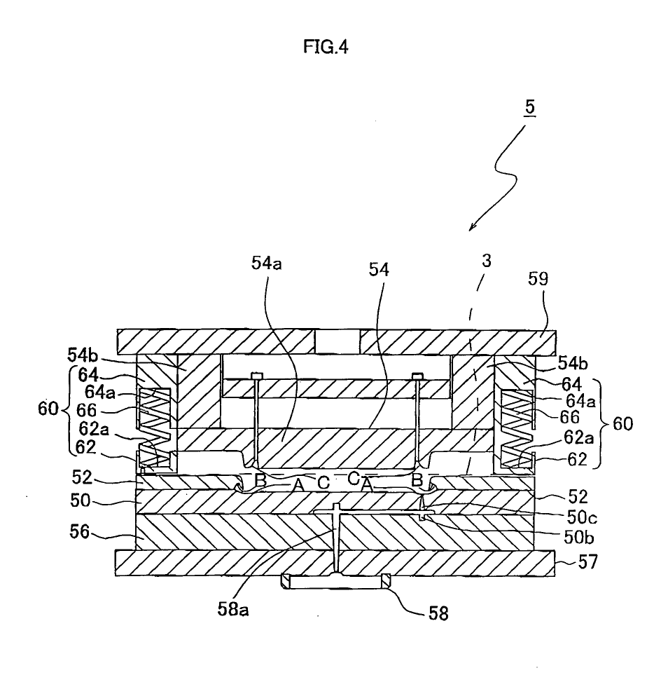

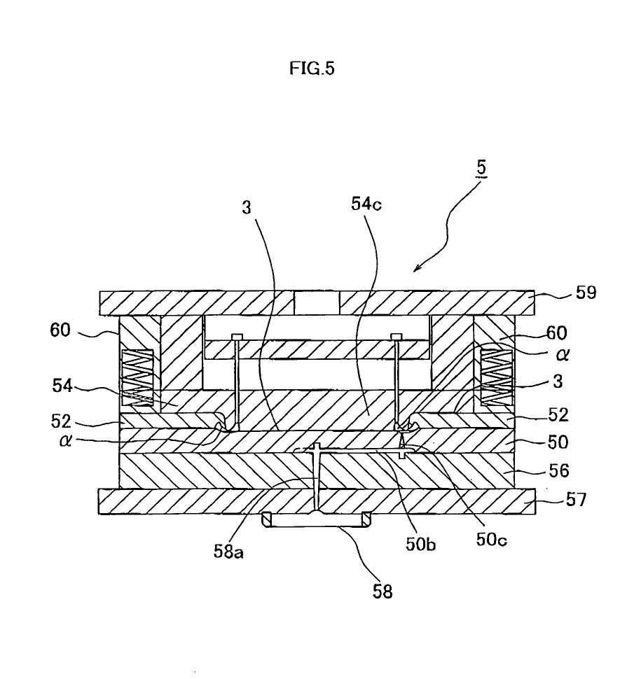

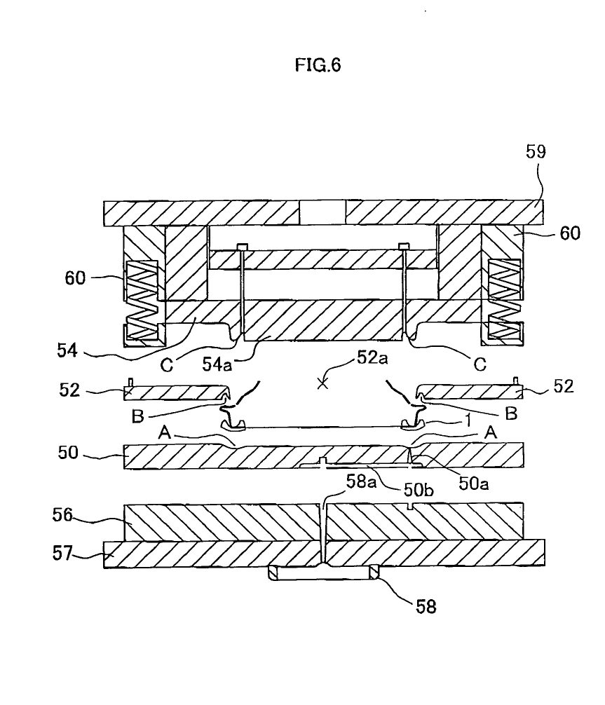

FIGS. 3 to 6 referred to in the description below respectively illustrate side elevations of the molding equipment. The figures show a net placed on the molding equipment (FIG. 3), the net held by a net holder (FIG. 4), a convex portion of the molding equipment inserted into an opening (FIG. 5), and removal of a molded resin frame with a net (FIG. 6). FIGS. 3 to 6 are partially perspective.

The molding equipment 5 of the present embodiment comprises a first, a second and a third mold, 50, 52, and 54; a first and a second fixed attachment board, 56 and 57; a projection unit attachment 58; a roof (movable attachment board) 59; and a net holder 60.

On the top surface of the first mold 50, Shape A is formed. Shape A defines the shape of the uncovered surface side of the fixture frame 10, that is, the opposite side to the covered surface side wherein the groove 12 is formed. On the bottom surface of the first mold 50, a gate 50b is formed in a grooved shape from a position facing gate 58a (to be described later) to a position immediately beneath the portion of the top surface wherein Shape A is formed. A gate 50c is formed leading from the gate 50b, and penetrating the first mold 50 up to the portion wherein Shape A is formed. When the first mold 50 is mounted onto the first attachment board 56 (shown in FIG. 4), the gate 50b forms a passageway and resin can be introduced from the gate 58a to the gate 50c.

On the second mold 52, an opening 52a is formed. Shape B is formed on the bottom surface of the second mold 52, proximate to where the opening 52a is abutted by the remainder of the mold 52. Shape B defines the shape of a portion of the covered surface side of the fixture frame 10, exterior (i.e. outside of the perimeter created by the cut section 32a) to the part where the cut section 32a is formed. Moreover, on the outer end of the top surface of the second mold 52, nails, pins, or other appropriate holding mechanisms 52b are disposed so as to temporarily hold the net.

The third mold 54 comprises a convex portion (protrusion) 54a insertable in the opening 52a. Shape C is formed near the edge of the bottom surface of the convex portion 54a. Shape C defines the shape of a portion of the covered surface side of the fixture frame 10, interior (i.e. inside the perimeter created by the cut section 32a) to the part where the cut section 32a is formed. The third mold 54 is fixed to the roof 59 by fixture(s) 54b.

The first to third molds, 50, 52, and 54, are constituted so as to form thereamong a molding space a (shown in FIG. 5) in the shape of the fixture frame 10. The molding space α is formed when the convex portion 54a is inserted into the opening 52a and the third mold 54 is placed onto the second mold 52, and when subsequently these two molds 52 and 54 are placed onto the first mold 50.

The first attachment board 56 is disposed onto the second attachment board 57. The aforementioned gate 58a is formed so as to penetrate these two attachment boards 56 and 57 from the projection unit attachment 58, formed on the bottom surface of the second attachment board 57.

The projection unit attachment 58 is capable of being attached to the spout of a projection unit (not shown) which can project (inject) resin.

The net holder 60 is respectively disposed abutting the outer surface of the third mold 54, and is fixed to the roof 59. The net holder 60 is constituted by a holder 62, a body 64, and a spring 66. The body 64 is fixed to the roof 59 and an opening 64a for spring attachment is formed in the free end thereof. The holder 62 is attached to the free end of the body 64 via contact with the spring 66. An opening 62a for spring attachment is formed in the end of the holder 62 to which the body 64 is facing. The spring 66 is attached to the body 64 and holder 62 in the openings 64a and 62a respectively disposed in the body 64 and holder 62. The spring is biased in a direction so as to keep the holder 62 away from the body 64.

In order to make a resin frame 1 with a net by using the molding equipment 5 described above, firstly a net is hooked on the holding mechanisms 52b and spread on (extended over) the second mold 52 so as to cover the opening 52a. Secondly, as the roof 59 is lowered, the holder 62 comes in contact with and is attached to the net 3 extended over the second mold 52. The spring 66 is compressed so as to press (hold) the net 3 against the second mold 52. When the roof 59 is lowered even further, the convex portion 54a of the third mold 54 presses the area of the net 3 covering the opening 52a, and the convex portion 54a is inserted into the opening 52a. Consequently, the net 3 is sandwiched between the first and third molds 50 and 54 (shown in FIG. 5). In this state, the net 3 extends from the molding space α via the sandwiched area defined between the convex portion 54a of the third mold 54 and the opening 52a of the second mold 52. The sandwiched area includes a portion wherein the cut section 32a is to be formed. When resin is projected into the molding space a through the gates 58a, 50b, and 50c, and subsequently solidifies, the net 30 inside the fixture frame 10 is fixed within the fixture frame 10. A resin frame 1 is formed with the net 32 outside of the fixture frame 10 protruding from the groove 12 (shown in FIG. 6).

Accordingly, when the net 32 outside of the fixture frame 10 of the resin frame 1, formed as above, is removed, the resin frame 1 is completed. The net 30 extends within the fixture frame 10 and is configured in a visually presentable manner.

In the present exemplary embodiment, the resin frame with a net is applied to a resin frame for use as a back rest and/or a seat of a chair. The resin frame with a net can also be applied to other kinds and types of resin frames used, for example, as a partition or a filter of an air conditioner. In addition, the net may be replaced by material such as cloth, fabric, or other sheet type material compatible with a specific use.

Moreover, it is described in the exemplary embodiment that the cut section 32a is formed on or near the groove 12. The cut section 32a can be formed at other locations, such as a place where the cut section 32a is covered, or a place where the cut section 32a is not covered and yet not conspicuous (visually apparent) from outside.

Furthermore, the resin frame as described in the exemplary embodiment is in an almost square configuration. However, the shape is not to be limited to a square, but the shape can also be polygonal, triangular, oval, or circular, among other geometric shapes and combinations.

In addition, the configuration of the resin frame with a net is not limited to the essentially two dimensional shape shown. The frame may also be configured in a third dimension (i.e. vertically in FIGS. 2 to 5) as is know in the art. For example, the seat back could be curved in the third dimension so as to more comfortably accommodate a seated person.

Still furthermore, the molding equipment 5 can comprise plurality of holders 60. In this case, each net holder 60 may respectively have a holder 62, a body 64, and a spring 66. The function of the plurality of net holders 60 all together corresponds to that of the net holder 60 in the above-described embodiment.

As mentioned above, modifications are possible in the exemplary embodiment described above without materially departing from the novel teaching and advantages of this invention. All such modifications are intended to be included within the scope of this invention.

1. A resin frame comprising;
a net,
a fixture frame comprising,
a covered surface side, and
wherein resin is injected to form the fixture frame so as to enclose at least a part of the net, and
a cut section formed by removing of at least a part of the net not enclosed by the fixture frame,
wherein the cut section is located on the covered surface side of the fixture frame which is at least partially concealed when the resin frame is attached to an attachment target.

2. A manufacturing method of the resin frame according to claim 1,
wherein molding equipment comprises a first mold, a second mold, and a third mold,
wherein the first mold comprises a shape to form an uncovered surface side of the fixture frame,
wherein the second mold comprises;
an opening, and
a shape to form a first portion of the covered surface side of the fixture frame,
wherein the third mold comprises;
a convex portion engagable with the opening of the second mold, and
a shape to form a second portion of the covered surface side of the fixture frame,
wherein the first portion of the covered surface side of the fixture frame and the second portion of the covered surface side of the fixture frame form the covered surface side of the fixture frame,
wherein the second mold is located between the first mold and the third mold, and
the manufacturing method comprises steps of:
spreading the net to cover the opening of the second mold, the net located between the second mold and the third mold;
inserting the convex portion of the third mold into the opening of the second mold;
projecting resin into a molding space formed by the interaction of the first mold, the second mold, and the third mold, and
removing at least a part of the net not enclosed by the fixture frame.

3. The manufacturing method as set forth in claim 2,
wherein the molding equipment further comprises at least one holder to temporarily hold the net in place,
and wherein the manufacturing method further comprises a step of pressing the net covering the opening with the at least one holder before the step of inserting the convex portion of the third mold into the opening of the second mold.

4. Molding apparatus used in the manufacturing method according to claim 2 comprising;
a fist mold, and
a second mold, and
a third mold,
wherein the first mold comprises;
a shape to form an uncovered surface side of the fixture frame on a top surface of the first mold,
wherein the second mold comprises;
an opening, and
a shape to form a first portion of the covered surface side of the fixture frame,
wherein the first portion is located exterior to where the cut section is formed on a bottom surface of the second mold,
wherein the third mold comprises;
a convex portion engagable with the opening of the second mold, and
a shape to form a second portion of the covered surface side of the fixture frame interior to where the cut section is formed on a bottom surface of the convex portion, and
wherein the first portion of the covered surface side and the second portion of the covered surface side combine to define an engagement groove,
wherein a molding space in a shape of the fixture frame is formed by the interaction between the first mold, the second mold, and the third mold, when the convex portion of the third mold is inserted into the opening of the second mold, and when the second and third molds are placed on to the first mold.

5. The molding apparatus as set forth in claim 4,
wherein the first portion of the covered surface side is located proximate to the opening and the second portion of the covered surface side is located proximate to an edge of the bottom surface of the convex portion.

6. A resin frame comprising
a thin sheet material,
a fixture frame,
wherein resin forms the fixture frame enclosing at least a portion of the thin sheet material, and
a cut section established by the removal of at least a part of the thin sheet material not enclosed by the fixture frame,
wherein the cut section is located in an area near the fixture frame where the thin sheet material was removed,
wherein at least a part of the cut section is not visible when the resin frame is attached to an attachment target.

7. The resin frame as set forth in claim 6, wherein
the thin sheet material is a net.

8. The resin frame as set forth in claim 6, wherein
the thin sheet material is a fabric.

9. The resin frame as set forth in claim 6, further comprising
an attachment groove located in at least one surface of the fixture frame formed so as to allow the fixture frame to be attached to an attachment target,
wherein the cut section is located in the attachment groove.

10. The resin frame as set forth in claim 9, wherein
the thin sheet material is a net.

11. The resin frame as set forth in claim 9, wherein
the thin sheet material not enclosed by the fixture frame protrudes from the attachment groove.

12. The resin frame as set forth in claim 11, wherein
the thin sheet material not enclosed by the fixture frame protrudes from the attachment groove at an angle to the thin sheet material enclosed by the fixture frame.

13. The resin frame as set forth in claim 11, wherein
the attachment target is a chair frame.

14. The resin frame as set forth in claim 9, wherein
the attachment target is a chair frame.

15. The resin frame as set forth in claim 6, wherein
the attachment target is a chair frame.

16. A resin frame comprising;
a net,
a fixture frame comprising,
a covered surface side comprising,
an attachment groove for attaching an attachment target to the fixture frame,
a non-covered surface side,
wherein resin is injected to form the fixture frame so as to enclose at least a portion of the net, and
wherein the portion of the net not enclosed by the fixture frame protrudes at least in part from the attachment groove,
wherein the portion of the net protruding from the attachment groove protrudes at an angle to the portion of the net enclosed by the fixture frame,
a cut section formed by removing of at least a part of the net not enclosed by the fixture frame,
wherein the cut section is located proximate to the attachment groove,
wherein at least part of the cut section is invisibly concealed by the attachment target after attaching the fixture frame to the attachment target.

17. The resin frame as set forth in claim 16, wherein
the attachment target is a chair frame.
